(19) United States
(12) Patent Application Publication
(10) Pub. No.: US 2013/0063050 A1
(43) Pub. Date: Mar. 14, 2013

(54) ELECTRONIC DEVICE, LIGHT EMITTING UNIT, AND LIGHT-TRANSMISSIVE PANEL

(71) Applicants: Hiroya MORIKAWA, Osaka (JP); Eiji SAITOU, Osaka (JP); Kazuhiko SHIBATA, Kyoto (JP)

(72) Inventors: Hiroya MORIKAWA, Osaka (JP); Eiji SAITOU, Osaka (JP); Kazuhiko SHIBATA, Kyoto (JP)

(73) Assignee: PANASONIC CORPORATION, Osaka (JP)

(21) Appl. No.: 13/452,059

(22) Filed: Apr. 20, 2012

(30) Foreign Application Priority Data
Sep. 13, 2011 (JP) 2011-199300

(51) Int. Cl. H05B 37/00; F21V 13/08

(52) U.S. Cl. 315/316; 362/293; 362/235; 362/343; 315/313

(57) ABSTRACT

An electronic device capable of displaying a light pattern in a section of a surface by turning on a light source includes: the light source; a first light-transmissive colored layer provided on the surface and having reflectance and transmittance that peak in a wavelength range of light of a first color; and a second light-transmissive colored layer provided on a path of light that is emitted from the light source and reaches the first light-transmissive colored layer, the second light-transmissive colored layer having transmittance that peaks in a wavelength range of light of a second color different from the first color. The second light-transmissive colored layer has light transmission characteristics adjusted such that light of a desired color exits the section of the surface where the light emitted from the light source reaches when the light source is turned on.

### BACKGROUND OF THE INVENTION

1. Field of the Invention

The present invention relates to a device that uses a general-purpose material to display a light pattern (for example, a logo) of desired color and shape on a surface of the device.

2. Description of the Related Art

There have been conventionally known light emitting devices on which different colors are visible when the light source is turned off and when the light source is turned on. For example, in a light emitting device described in Japanese Patent Application Laid-open No. H06-19411, the color of light emitted from a light source and transmitted through a surface member is visible when the light source is turned on, whereas the color of ambient light reflected on the surface is visible when the light source is turned off. This device accomplishes presenting to view distinctively different colors when the light emitting device is turned off and when the light emitting device is turned on by using a special coating film which has the characteristics described above as a color variable member.

The conventional light emitting device requiring a special coating film which gives reflected light and transmitted light different colors cannot obtain a desired color by mixing general-purpose paints freely. The resultant problem is that, when used in an electronic device such as a portable device to display a logo or the like, the light emitting device described above limits the body color of the product and the color of the logo.

Further, in the case of a product such as the above-mentioned portable device that comes in a variation of colors, it is desirable from the standpoint of mounting process to use a common light source in all variations of the product irrespective of color differences, and varying the color of light emitted from the light source from one product color to another is therefore not a practical adjustment.

### SUMMARY OF THE INVENTION

The present invention solves the problems of prior art described above by providing a technology for presenting to view light of different color tones when a light source is turned on and when the light source is turned off by using a material that gives reflected light and transmitted light similar color tones.

The present invention also provides a technology for improving the degree of freedom in selecting colors of light that are visible when the light source is turned on and when the light source is turned off.

According to an exemplary embodiment of the present invention, there is provided an electronic device for displaying a light pattern in a section of a surface by turning on a light source. The electronic device includes: the light source; a first light-transmissive colored layer provided on the surface and has reflectance and transmittance that peak in a wavelength range of light of a first color; and a second light-transmissive colored layer provided on a path of light that is emitted from the light source and reaches the first light-transmissive colored layer, the second light-transmissive colored layer having transmittance that peaks in a wavelength range of light of a second color different from the first color. The second light-transmissive colored layer has light transmission characteristics adjusted such that light of a desired color exits the section of the surface where the light emitted from the light source reaches when the light source is turned on.

In another exemplary embodiment, the electronic device further includes a light shielding layer disposed between the light source and the first light-transmissive colored layer, a part of the light shielding layer including a light transmitting pattern. The second light-transmissive colored layer is placed along a path of light being emitted from the light source, transmitted through the light transmitting pattern, and reaching the first light-transmissive colored layer. The second light-transmissive colored layer has light transmission characteristics adjusted such that light of a desired color exits the section of the surface where the light emitted from the light source and transmitted through the light transmitting pattern reaches when the light source is turned on.

In yet another exemplary embodiment, the light source is an aggregation of a plurality of light source components arranged so as to display the light pattern in the section of the surface.

In yet another exemplary embodiment, in the section of the surface, light reflected from the first light-transmissive colored layer is visible when the light source is turned off, and a color of light emitted from the light source and transmitted through the second light-transmissive colored layer and the first light-transmissive colored layer is visible when the light source is turned on.

In yet another exemplary embodiment, the second light-transmissive colored layer has light transmission characteristics adjusted such that light having the same color as that of light emitted from the light source exits the section of the surface when the light source is turned on.

In yet another exemplary embodiment, the second color is a complementary color of the first color.

In yet another exemplary embodiment, one of the first color and the second color is a color selected from the group consisting of red, green, and blue.

In yet another exemplary embodiment, the light source is a white light source.

In yet another exemplary embodiment, the first light-transmissive colored layer and the second light-transmissive colored layer are each made from one of ink and paint.

In yet another exemplary embodiment, the light transmitting pattern is shaped like one of letters and a graphic form.

In yet another exemplary embodiment, the electronic device further includes: an input interface configured to receive an instruction from a user; and a processor configured to control turning on and off of the light source based on the instruction from the user.

In yet another exemplary embodiment, the electronic device further includes: a sensor configured to detect a tilt; and a processor configured to control turning on and off of the light source based on the tilt detected by the sensor.

According to an exemplary embodiment of the present invention, there is provided a light emitting unit configured to display a light pattern in a section of a surface of a device by turning on a light source. The light emitting unit includes: the light source; a first light-transmissive colored layer having reflectance and transmittance that peak in a wavelength range of light of a first color; and a second light-transmissive colored layer provided on a path of light that is emitted from the light source and reaches the first light-transmissive colored layer, the second light-transmissive colored layer having transmittance that peaks in a wavelength range of light of a second color different from the first color. The second light-transmissive colored layer has light transmission characteristics adjusted such that light of a desired color exits the section of the surface where the light emitted from the light source reaches when the light source is turned on.

In another exemplary embodiment, the light emitting unit further includes a light shielding layer disposed between the light source and the first light-transmissive colored layer, the light shielding layer including a light transmitting pattern. The second light-transmissive colored layer is placed along a path of light being emitted from the light source, transmitted through the light transmitting pattern, and reaching the first light-transmissive colored layer. The second light-transmissive colored layer has light transmission characteristics adjusted such that light of a desired color exits the section of the surface where the light emitted from the light source and transmitted through the light transmitting pattern reaches when the light source is turned on.

In yet another exemplary embodiment, the light source is an aggregation of a plurality of light source components arranged so as to display the light pattern in the section of the surface.

According to an exemplary embodiment of the present invention, there is provided a light-transmissive panel for use in an electronic device for displaying a light pattern in a section of a surface by turning on a light source. The light-transmissive panel includes: a first light-transmissive colored layer having reflectance and transmittance that peak in a wavelength range of light of a first color; and a second light-transmissive colored layer provided on a path of light that is emitted from the light source and reaches the first light-transmissive colored layer, the second light-transmissive colored layer having transmittance that peaks in a wavelength range of light of a second color different from the first color. The second light-transmissive colored layer has light transmission characteristics adjusted such that light emitted from the light source and transmitted through the first light-transmissive colored layer has a desired color when the light source is turned on.

In another exemplary embodiment, the light-transmissive panel further includes a light shielding layer disposed close to the first light-transmissive colored layer, a part of the light shielding layer including a light transmitting pattern. The second light-transmissive colored layer is placed along a path of light being emitted from the light source, transmitted through the light transmitting pattern, and reaching the first light-transmissive colored layer. The second light-transmissive colored layer has light transmission characteristics adjusted such that light being emitted from the light source, transmitted through the light transmitting pattern, and exiting the first light-transmissive colored layer has a desired color when the light source is turned on.

According to yet another present invention, the color of ambient light reflected from the first light-transmissive colored layer is mainly visible when the light source is turned off, and the color of light transmitted through the second light-transmissive colored layer and the first light-transmissive colored layer both is visible when the light source is turned on. The present invention therefore does not need such a coating film having special characteristics as the one used in conventional light emitting devices. As a result, a device on which distinctively different colors are visible when the device is turned off and when the device is turned on is realized at low cost.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a diagram illustrating the principle of pattern display by light according to an embodiment of the present invention.

FIG. 2A is a diagram illustrating an example of display that is observed when a light source is turned off and FIG. 2B is a diagram illustrating an example of display that is observed when the light source is turned on.

FIG. 3 is a diagram illustrating another structural example according to the embodiment of the present invention.

FIG. 4 is an exterior view of a screen unit of a digital photo frame according to the embodiment.

FIG. 5 is a plan view illustrating a colored layer of an acrylic panel according to the embodiment.

FIG. 6 is a plan view illustrating a light shielding layer of the acrylic panel according to the embodiment.

FIG. 7 is a plan view illustrating an emission color adjusting layer of the acrylic panel according to the embodiment.

FIG. 8A is a sectional view illustrating the structure around a logo portion of the digital photo frame according to the embodiment.

FIG. 8B is a sectional view illustrating another example of the structure around the logo portion of the digital photo frame according to the embodiment.

FIG. 8C is a sectional view illustrating still another example of the structure around the logo portion of the digital photo frame according to the embodiment.

FIGS. 9A and 9B are diagrams illustrating reflected light in the colored layer.

FIGS. 10A to 10C are diagrams illustrating a first example of spectral distributions of light that exits a logo light unit 14, light that is transmitted through one layer, and light that is transmitted through a different layer.

FIGS. 11A to 11C are diagrams illustrating a second example of spectral distributions of light that exits the logo light unit 14, light that is transmitted through one layer, and light that is transmitted through a different layer.

FIGS. 12A to 12C are diagrams illustrating a third example of spectral distributions of light that exits the logo light unit 14, light that is transmitted through one layer, and light that is transmitted through a different layer.

FIG. 13 is a block diagram illustrating an example of a structure relevant to processing of the digital photo frame.

FIG. 14 is a diagram illustrating an example of a function of the digital photo frame.

FIG. 15A is a diagram illustrating an example of a television set or a display to which a light emission method according to the present invention is applied.

FIG. 15B is a diagram illustrating an example of a personal digital assistant to which the light emission method according to the present invention is applied.

### DETAILED DESCRIPTION OF PREFERRED EMBODIMENT

An embodiment of the present invention is described below with reference to the drawings. Before a description of a specific embodiment is given, a basic structure and principle according to the embodiment of the present invention are described.

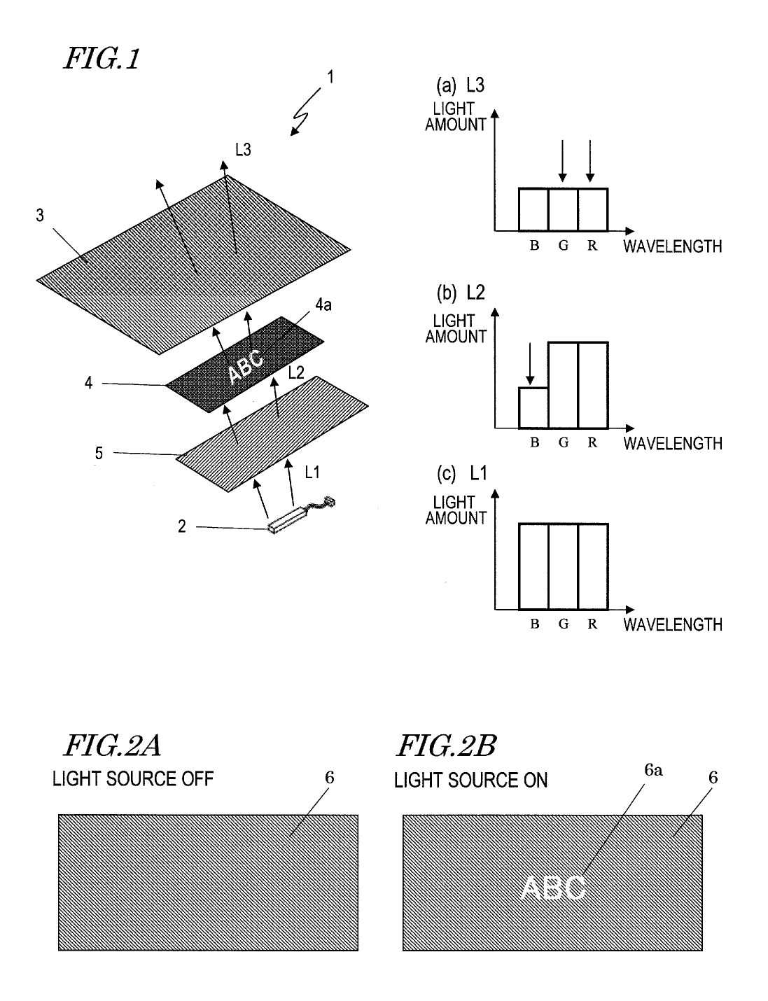

FIG. 1 is a diagram schematically illustrating a first basic structure example of a light emitting unit 1 for use in an electronic device according to the embodiment of the present invention. The light emitting unit 1 includes a light source 2, a first light-transmissive colored layer 3 whose reflectance and transmittance peak in the wavelength range of light having a first color, a light shielding layer 4, a part of which has a light transmitting pattern 4a, and a second light-transmissive colored layer 5 whose transmittance peaks in the wavelength range of light having a second color, which differs from the first color. FIG. 1 illustrates the first light-transmissive colored layer 3, the light shielding layer 4, and the second light-transmissive colored layer 5 as though the layers are spaced apart from one another, but these layers are disposed close to one another in an actual device. The arrows of FIG. 1 represent beams of light. One of the first color and the second color is typically set to a primary color (red, green, or blue), but may be set to other colors.

The light source 2 can be a general-purpose light source such as a light emitting diode, a fluorescent lamp, or a light bulb. The light source 2 emits white light in the illustrated example, but may emit other types of light than white light.

The first light-transmissive colored layer 3 have a reflectance and a transmittance that peak in the wavelength range of the first color light as described above. The first light-transmissive colored layer 3 can be made from a general-purpose material such as light-transmissive ink, paint, or color filter. The first light-transmissive colored layer 3 is typically provided on a surface of the device. Accordingly, the first color which is the main color of light reflected by the first light-transmissive colored layer 3 is visible on the surface of the device.

The light shielding layer 4 is made from non-light-transmissive material except the light transmitting pattern 4a, which constitutes a part of the light shielding layer 4, and is disposed between the first light-transmissive colored layer 3 and the light source 2. The light transmitting pattern 4a is formed in the shape of a pattern to be displayed on the surface of the device. The light transmitting pattern 4a is shaped like letters or a graphic form, and “ABC” is indicated in the example of FIG. 1. A logo or the like having a desired shape can be displayed on the device surface by giving the light transmitting pattern 4a the desired shape.

The second light-transmissive colored layer 5 is provided along the path of light that is emitted from the light source 2, is transmitted through the light transmitting pattern 4a, and reaches the first light-transmissive colored layer 3. The second light-transmissive colored layer 5 is interposed between the light shielding layer 4 and the light source 2 in the example of FIG. 1, but is not limited to this placement and may be disposed within the light transmitting pattern 4a, or between the first light-transmissive colored layer 3 and the light transmitting pattern 4a. The second light-transmissive colored layer 5 transmits mainly light having the second color and is preferably designed to absorb or reflect most of light having other colors. Similarly to the first light-transmissive colored layer 3, the second light-transmissive colored layer 5 can be made from a general-purpose material such as ink, paint, or a color filter. The light transmission characteristics of the second light-transmissive colored layer 5 are adjusted so as to give a desired color to light that is emitted from the light source 2 and transmitted through the light transmitting pattern 4a and the first light-transmissive colored layer 3.

Parts (a), (b), and (c) of FIG. 1 are diagrams illustrating the color of light that is emitted from the light source 2 and transmitted through the components of the light emitting unit 1. The following description is simplified by dividing the spectrum of light roughly into red (R), green (G), and blue (B). In the example discussed here, blue (B) is a color approximately corresponding to a wavelength range of 400 nm to 500 nm, green (G) is a color approximately corresponding to a wavelength range of 500 nm to 600 nm, and red (R) is a color approximately corresponding to a wavelength range of 600 nm to 700 nm. In the case where the first color or the second color is a mixture of light colors corresponding to a plurality of discontinuous wavelength ranges, such as magenta (red and blue), the “wavelength range” of this color is the combined range of the plurality of wavelength ranges.

Part (c) of FIG. 1 illustrates an example of the light amount distribution of color components of light L1 (hereinafter, sometimes referred to as “spectral distribution”) which has just been emitted from the light source 2. It is assumed that the light source 2 in this example emits ideal white light in which the color components R, G, and B have an equal light amount. Although no actual light source emits ideal white light as such, the ideal situation is assumed for the convenience of description.

Part (b) of FIG. 1 illustrates an example of the light amounts of the color components R, G, and B of light L2 which has been transmitted through the second light-transmissive colored layer 5. The second color in this example is yellow (a mixture of green and red). In other words, the second light-transmissive colored layer 5 transmits mainly green light and red light, and absorbs most of blue light. Most of the B light component is consequently lost when transmitted through the second light-transmissive colored layer 5 as illustrated in part (b) of FIG. 1.

The light transmitted through the second light-transmissive colored layer 5 enters the light shielding layer 4. Of the light incident on the light shielding layer 4, light that arrives at the region of the light transmitting pattern 4a is transmitted as it is whereas light that arrives at other regions is lost. Only the light transmitted through the light transmitting pattern 4a reaches the first light-transmissive colored layer 3 as a result. The light that is transmitted through the light transmitting pattern 4a and reaches the first light-transmissive colored layer 3, too, has the spectral distribution of part (b) of FIG. 1.

Part (a) of FIG. 1 illustrates an example of the light amounts of the color components R, G, and B of light L3 which has been transmitted through the first light-transmissive colored layer 3. The first color in this example is blue. In other words, the first light-transmissive colored layer 3 transmits mainly blue light and absorbs most of green light and red light. Consequently, as illustrated in part (a) of FIG. 1, most of the component G and most of the component R are lost when transmitted through the first light-transmissive colored layer 3, and white light in which the components R, G, and B have an approximately equal light amount exits the first light-transmissive colored layer 3. This is because the light transmission characteristics of the second light-transmissive colored layer 5 are adjusted in advance in a manner that makes light that exits the first light-transmissive colored layer 3 white light. To summarize, in the embodiment of the present invention, the color of light pattern to be displayed on the display surface and the color of light to be emitted from the light source 2 are determined in advance, and the light transmission characteristics of the second light-transmissive colored layer 5 are adjusted to suit these colors.

Through the above-mentioned process, a light pattern having the same shape as that of the light transmitting pattern 4a is displayed on the surface of the device when the light source 2 is turned on. The second color in the example described above is determined as yellow because it has been determined that the body color of the device is to be blue on the premise that the light source 2 used emits white light. In the case where light emitted from the light source 2 and the device body have other colors, the second color, too, is changed to a color suited to the colors of the emitted light and the device body.

FIGS. 2A and 2B are respectively diagrams illustrating an example of what is displayed on a surface 6 of the device when the light source 2 is turned off and when the light source 2 is turned on. A case where ambient light is white light and light emitted from the light source 2 is sufficiently more intense than the ambient light is assumed. As illustrated in FIG. 2A, when the light source 2 is turned off, the first color which is the main color of light reflected by the first light-transmissive colored layer 3 is visible all over the surface 6. When the light source 2 is turned on, on the other hand, the main color of light transmitted through the second light-transmissive colored layer 5 and the first light-transmissive colored layer 3 is visible as illustrated in FIG. 2B in a region 6a, which is a part of the surface 6 where light transmitted through the light transmitting pattern 4a reaches. In other regions of the surface 6, the first color is visible also when the light source 2 is turned on. Light pattern having the shape of the region 6a is displayed on the surface of the device as a result.

As described above, according to the embodiment of the present invention, a light pattern having a desired shape such as a logo can be displayed in a desired color on a surface of a device with the use of a general-purpose light source and a general-purpose light-transmissive material. The color of light emitted from the light source therefore does not need to be varied to match, for example, color variations of the electronic device, and a pattern can be displayed in a desired color merely by varying the light transmission characteristics of the second light-transmissive colored layer 5. In short, the embodiment of the present invention has a valuable effect in that light emission improved in flexibility and reduced in cost compared to conventional technologies is accomplished.

In the example described above, light pattern of an arbitrary shape is displayed by providing the light shielding layer 4 which has the light transmitting pattern 4a. The same result can be attained without providing the light shielding layer 4. The light shielding layer 4 can be omitted by using a light source that is capable of emitting light in the same pattern as a light pattern to be displayed on the surface. A second basic structure example of the embodiment of the present invention is described below.

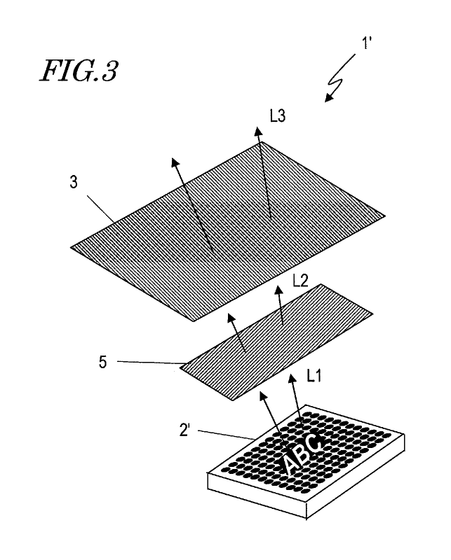

FIG. 3 is a diagram illustrating the second basic structure example according to the embodiment of the present invention. Unlike the light emitting unit 1 of FIG. 1, a light emitting unit 1′ of FIG. 3 has a light source 2′ which is capable of emitting light in a pattern corresponding to light pattern to be displayed on the device surface, instead of including the light shielding layer 4. The light source 2′ has a plurality of light source components arranged two-dimensionally, and generates a light pattern on the device surface by controlling the turning on/off of each light source component. In the example of FIG. 3, light source components at specific positions are turned on and the rest of the light source components are turned off such that a letter string “ABC” is expressed in a light pattern.

An advantage of the structure example of FIG. 3 is that the manufacture is easy because a step of forming the light shielding layer 4 which has the light transmitting pattern 4a can be omitted. It is particularly beneficial if a general-purpose light source such as a known dot matrix LED, 7-segment LED, or 14-segment LED is used as the light source 2′ and the manufacture cost is consequently reduced even more.

A more specific description of the embodiment of the present invention is given below.

### EMBODIMENT

Described first is a case where a light emitting unit according to the embodiment of the present invention is used in a digital photo frame.

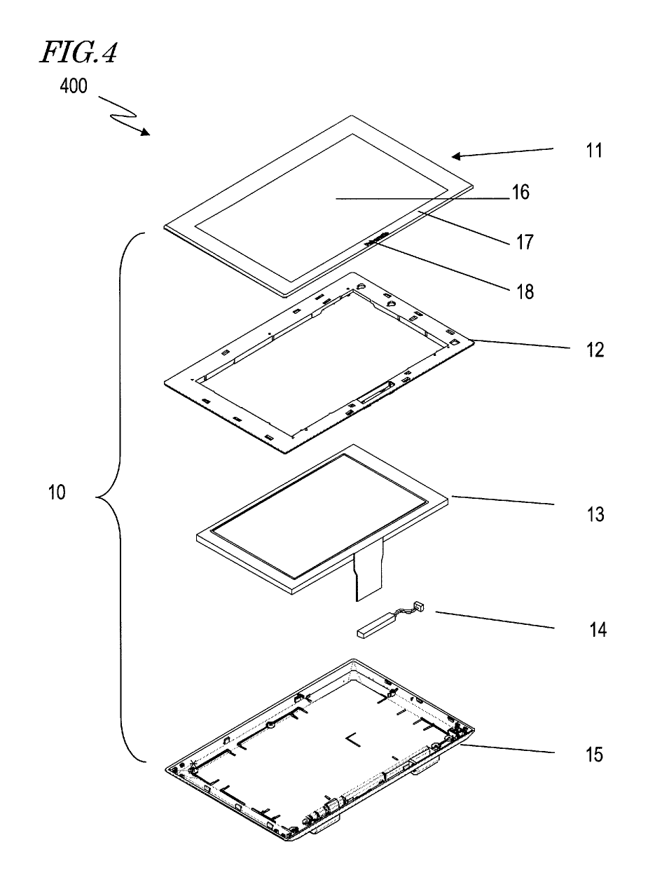

FIG. 4 is an exterior view of a screen unit 10 of a digital photo frame 400 according to this embodiment. The digital photo frame 400 includes other components than the screen unit 10, such as an integrated circuit which includes a processor and a memory, and a description of the other components is given later.

The screen unit 10 includes an acrylic panel 11, which serves as a base material transmissive of light, a front cover 12, an LCD unit 13, a logo light unit 14, which uses a white light source, and a back cover 15.

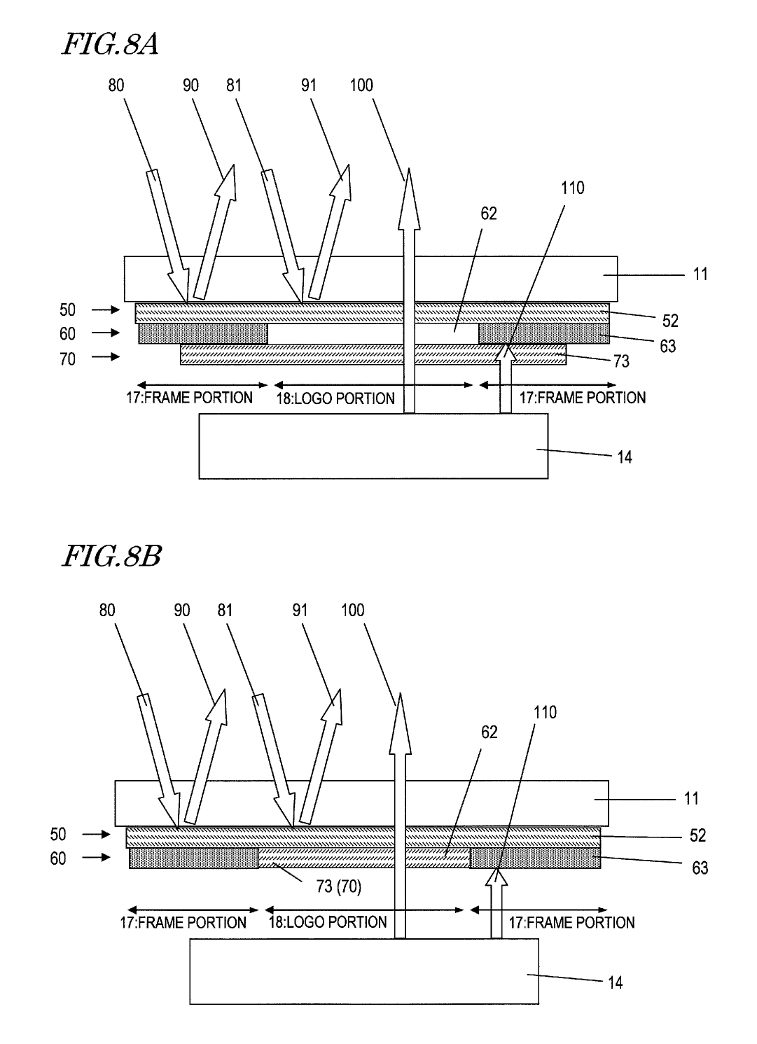

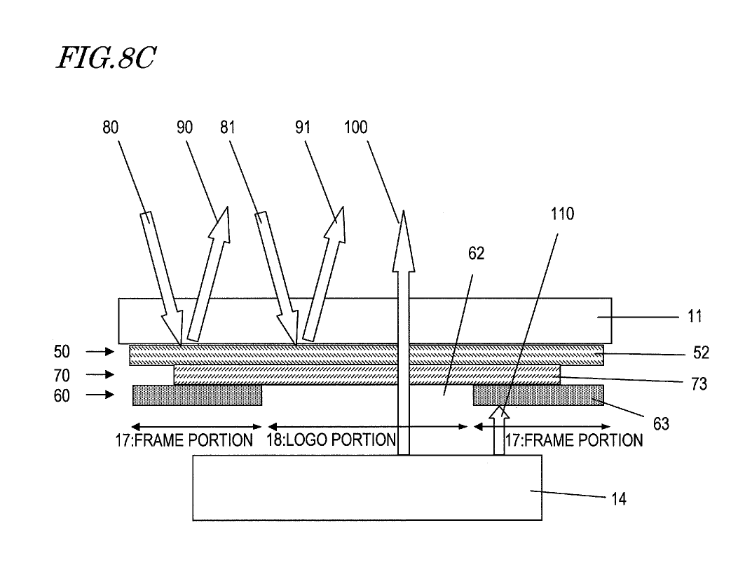

The acrylic panel 11 is a part bonded to the front cover 12 so as to cover the front side (the top side in FIG. 4) of the LCD unit 13 and the logo light unit 14. The back of the acrylic panel 11 is printed in some places. The acrylic panel 11 is constituted of a screen portion 16, through which what is displayed by the LCD unit 13 is transmitted to be viewed, a frame portion 17, which is the rest of the acrylic panel 11, and a logo portion 18, which is provided inside the frame portion 17. A colored layer 50, a light shielding layer 60, and an emission color adjusting layer 70 are formed on the back of the acrylic panel 11 by printing as described later with reference to FIGS. 8A to 8C.

The logo light unit 14 is a part for lighting up a brand logo provided in the logo portion 18 on the acrylic panel 11. The logo light unit 14 has, for example, a white light emitting diode and emits white light at a relatively high luminance. The logo portion 18 is visible only when the logo light unit 14 is turned on. When the logo light unit 14 is turned off, the logo portion 18 shows a color similar to that of the frame portion 17 and therefore is not visible or does not stand out.

The front cover 12 is a part for fixing the LCD unit 13 and the logo light unit 14 in an appropriate position lengthwise, widthwise, and front to back. The back cover 15 is a part for covering the back of the screen unit 10. The LCD unit 13 is a part for displaying a photograph or other images saved in a storage device such as a memory (not shown), and a screen of a graphical user interface (GUI).

FIG. 5 illustrates the colored layer 50, which constitutes the frame portion 17 and the screen portion 16 of the acrylic panel 11. The colored layer 50 includes an LCD transmission portion 51 through which display of the LCD unit 13 is seen and a colored portion 52. The hatched region in FIG. 5 which indicates the colored portion 52 is a region formed by printing. The peripheral thin line in FIG. 5 indicates the contour of the acrylic panel 11. A coating film is formed by printing with the use of an original printing plate designed to match the shape of the frame portion 17, and the color of the coating film is the color of the frame portion 17. The color of the colored portion 52 is pink (magenta) in this embodiment. Magenta is a mixture of red and blue.

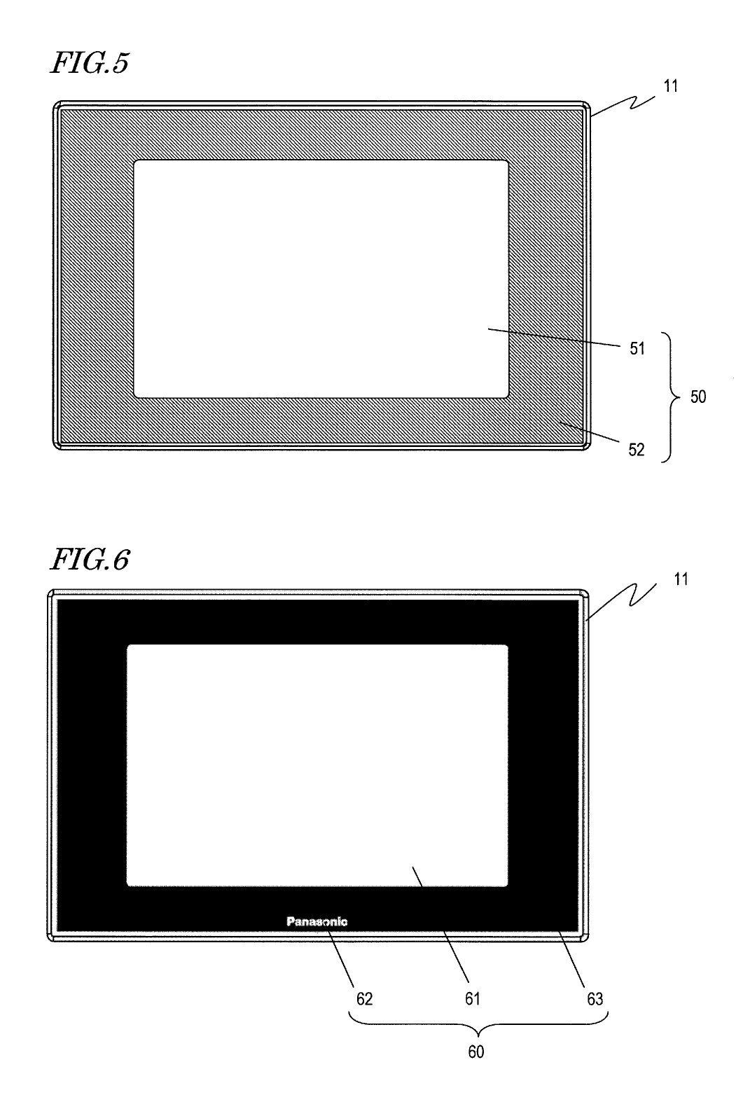

FIG. 6 illustrates the light shielding layer 60 for determining the light emission shape of the logo portion 18 of the acrylic panel 11. The light shielding layer 60 includes an LCD transmission portion 61 through which display of the LCD unit 13 is seen, a logo transmission portion 62 for making the logo portion 18 visible when the logo light unit 14 is turned on, and a light shielding portion 63. The black region in FIG. 6 which represents the light shielding portion 63 is a region formed by printing. The peripheral thin line in FIG. 6 indicates the contour of the acrylic panel 11. The light shielding portion 63 is formed by printing with the use of an original printing plate designed to match the shape of the frame portion 17, and does not transmit light. The color of the light shielding portion 63 is silver in this embodiment.

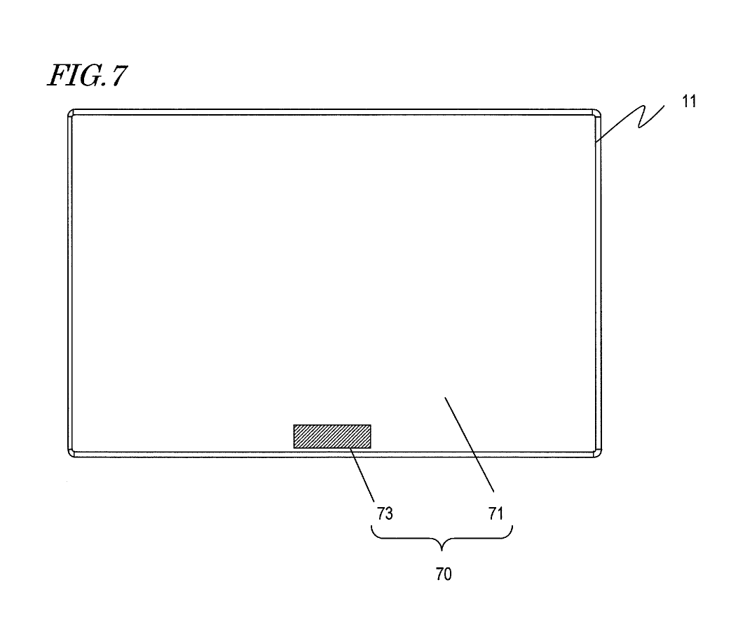

FIG. 7 illustrates the emission color adjusting layer 70 for adjusting the emission color of the logo portion 18 in the acrylic panel 11. The light shielding portion 63 includes an emission color adjusting portion 73 and a rest portion 71. The hatched region in FIG. 7 which represents the emission color adjusting portion 73 is a region formed by printing. The peripheral thin line in FIG. 7 indicates the contour of the acrylic panel 11. The color of the emission color adjusting portion 73 in this embodiment is green, which is the complimentary color of the color of the colored layer 50.

In this embodiment, three types of original printing plates for forming the colored layer 50, the light shielding layer 60, and the emission color adjusting layer 70 are used to form an ink layer structure on the acrylic panel 11. Any known printing method can be employed but, from the standpoint of manufacture cost and difficulty, using silk printing is considered to be the best. With silk printing, the logo transmission portion 62 is created by applying ink onto a mesh sheet shaped into the desired shape. The manufacture method for the layers is not limited to printing and the material of the layers is not limited to ink. Other materials for the layers than ink can be, for example, paint, tape, or a filter.

A description is given below of the structures of the respective layers formed on the base material of the acrylic panel 11 with the use of the three types of original printing plates described above.

FIG. 8A is a schematic diagram illustrating the sectional structure around the logo portion 18 of the acrylic panel 11, light incident from the outside, and light emitted from the logo light unit 14. The colored layer 50, the light shielding layer 60, and the emission color adjusting layer 70 are formed on the acrylic panel 11 by printing. The logo light unit 14 is disposed behind the layers. In this embodiment, the colored portion 52, the logo transmission portion 62, and the light shielding portion 63 are formed in order by printing on the same acrylic panel 11. Therefore, in the actual sectional structure, the ink of the emission color adjusting portion 73 flows into the logo transmission portion 62, thereby bringing the emission color adjusting portion 73 into direct contact with the colored portion 52. In short, the actual structure around the logo portion 18 of the acrylic panel 11 is close to a structure illustrated in FIG. 8B. The logo transmission portion 62 in FIG. 8A is illustrated as an empty space for easier understanding of the layer structure.

The colored layer 50, the light shielding layer 60, and the emission color adjusting portion 73 which are formed by printing in this embodiment may be formed by other methods. Other methods of forming the layers than printing include, for example, application and sticking a sheet or tape. In the case where the emission color adjusting layer 70 is implemented by a transmissive sheet or tape, an empty space is created between the colored layer 50 and the emission color adjusting layer 70 as illustrated in FIG. 8A.

The emission color adjusting layer 70 may be provided between the colored layer 50 and the light shielding layer 60 as illustrated in FIG. 8C. The effect of this embodiment is obtained as long as the emission color adjusting layer 70 is provided along the path of light that is emitted from the logo light unit 14, is transmitted through the logo transmission portion 62, and reaches the colored layer 50.

In this embodiment, the colored layer 50 functions as the first light-transmissive colored layer of the present invention, the light shielding layer 60 functions as the light shielding layer of the present invention, the emission color adjusting layer 70 functions as the second light-transmissive colored layer of the present invention, and the logo light unit 14 functions as the light source of the present invention.

The emission color adjusting layer 70 is provided closer to the logo light unit 14 than the colored layer 50 is. With this structure, the color of ambient light reflected by the colored layer 50 is mainly visible when the light source is turned off, and the color of light transmitted through the emission color adjusting layer 70 and the colored layer 50 both is visible when the light source is turned on. In addition, a light emission pattern of an arbitrary shape can be obtained irrespective of the shape of the light source because the light shielding layer 60 is provided to partially block light from the light source.

How the logo portion 18 provided in the frame portion 17 of the acrylic panel 11 is made visible is described below.

In FIGS. 8A to 8C, incident light 80 is ambient light that enters the colored portion 52 and reflected light 90 is reflected light of the incident light 80. Incident light 81 is ambient light that enters a region on the colored portion 52 that is opposite from the logo transmission portion 62. Reflected light 91 is reflected light of incident light 81. Transmitted light 100 is light that is emitted from the logo light unit 14 and transmitted through the emission color adjusting portion 73 and the colored portion 52. Lost light 110 is light that is emitted from the logo light unit 14 and is lost upon entering the light shielding portion 63.

The frame portion 17 of the acrylic panel 11 is visible as the reflected light 90. When the logo light unit 14 is turned off, the color of the reflected light 91 is substantially the same as that of the reflected light 90 and the logo portion 18 is therefore not visible or does not stand out. A part of the incident light 80 reaches the light shielding portion 63, thereby causing reflection from the light shielding portion 63. The reflected light 91 and the reflected light 90 are therefore not completely the same in color and light amount. The light shielding portion 63 in this embodiment is silver as mentioned above in order to minimize the influence of the color of the light shielding portion 63 on the reflected light 90. However, the light shielding portion 63 does not always need to be silver and can have any color as long as light from the light source can be blocked.

FIGS. 9A and 9B are diagrams illustrating the relation between the incident light 80 and the reflected light 90 or between the incident light 81 and the reflected light 91. FIG. 9A illustrates an example of the spectral distribution of the incident light 80 and the incident light 81, and FIG. 9B illustrates an example of the spectral distribution of the reflected light 90 and the reflected light 91. The incident light 80 and the incident light 81 illustrated in FIG. 9A are reflected by the colored layer 50, losing most of green wavelength range light alone, and consequently turn into magenta (pink) colored light which includes a large amount of red wavelength range light and blue wavelength range light. FIGS. 9A and 9B assumes for the convenience of description that ambient light is ideal white light which includes the color components R, G, and B in equal amounts. White light in reality does not have this spectral distribution and the light amount generally varies depending on the wavelength. The description given here also assumes for simplification that green light alone is lost when the incident light is reflected, but a small amount of the red color component light and the blue color component light is generally lost as well.

When the logo light unit 14 is turned on, on the other hand, combined light of the transmitted light 100 and the reflected light 91 is visible. In this embodiment, the light amount of the logo light unit 14 is set such that the light amount of the transmitted light 100 is much larger than the light amount of the reflected light 91, and the color of the reflected light 91 is therefore not discernible and most of the visible color is the color of the transmitted light 100. The transmitted light 100 of the logo light unit 14 is made to look white by the following two-stage processing.

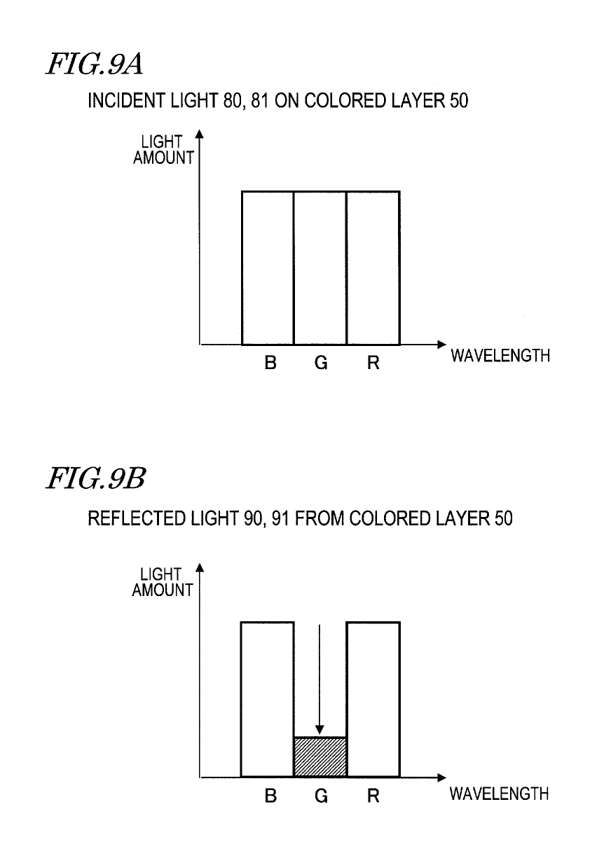

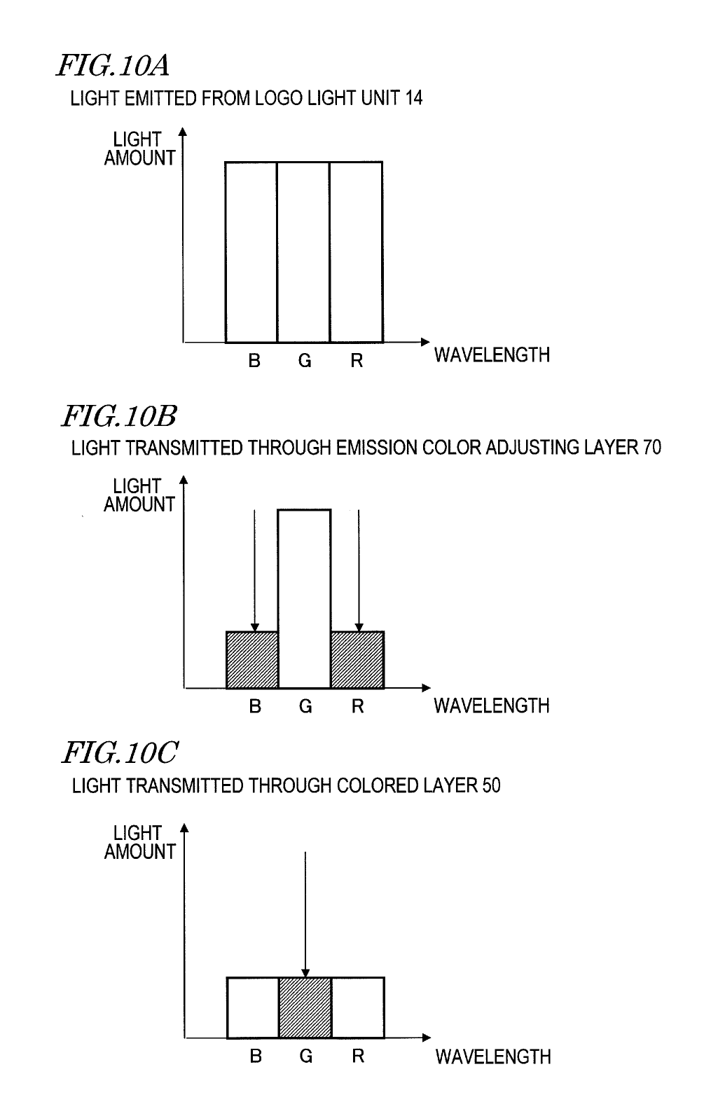

FIGS. 10A to 10C are diagrams illustrating the principle of turning the transmitted light 100 into white light. FIG. 10A is a graph illustrating the spectral distribution of light that has just been emitted from the logo light unit 14. White light emitted from the logo light unit 14 is first converted by the emission color adjusting layer 70 into green light as the complementary color of the colored layer 50, and then transmitted through the logo transmission portion 62 before reaching the colored layer 50. This is because the red color component and the blue color component that are included in the white light are mostly lost when the white light is transmitted through the emission color adjusting layer 70 as illustrated in FIG. 10B. In this case, the red component and the blue component are, however, not completely lost and maintain some light amount, albeit relatively small compared to the green component. This green light is next transmitted through the colored layer 50, which is pink, and is thus made to look white. This is because most of the green component is lost when the green light is transmitted through the colored layer 50 and becomes substantially equal in light amount to the red component and the blue component as illustrated in FIG. 10C. In this manner, the logo portion 18 is made visible in the same white light that is emitted from the logo light unit 14, despite the darkening of the emitted light of the logo light unit 14 in the colored layer 50, through color conversion processing that combines the color of the emission color adjusting layer 70 and the color of the colored layer 50.

A part of light emitted from the logo light unit 14 that reaches other regions than the logo transmission portion 62 is blocked by the light shielding portion 63 and becomes the lost light 110, which is not visible. Accordingly, a light pattern that is exactly the same as the shape of the logo transmission portion 62 can be made visible by using the logo light unit 14 which is shaped for general use.

As described above, the digital photo frame 400 of this embodiment presents to view light of completely different color tones when the light source is turned on and when the light source is turned off by using a general-purpose ink which gives reflected light and transmitted light similar color tones, instead of using a special paint. In the case where the selected color variation of the frame portion 17 is pink as in the digital photo frame 400 of this embodiment, the device may be designed to display a logo in white only when the light source is turned on whereas the logo portion 18 appears pink like its surrounding region when the light source is turned off. The color of the digital photo frame 400 is not limited to pink and, when a different color is selected, the same effect can be obtained with the identical logo light unit 14 by giving the emission color adjusting layer 70 light transmission characteristics suited to the selected color.

This embodiment can thus fulfill both the demand for manufacturing a plurality of types of products in a variation of colors by varying the color of the frame portion and the demand for using the same color light source for all of the frame color variations. In other words, this embodiment has a valuable effect in that a desired body color and a desired light emission color are obtained with the same light source by merely varying the colored layer 50 and the emission color adjusting layer 70. Another effect of this embodiment is that, because the colored layer 50 and the emission color adjusting layer 70 can be provided on the same acrylic panel 11, models having color variations are easily produced by giving the other parts of the product than the acrylic panel 11 a shared design and simply switching the acrylic panel 11.

The effects of this embodiment could be obtained without the emission color adjusting layer 70 by changing the light source to one that emits green light itself. However, if the emission color adjusting layer 70 is not provided, the light source used needs to be capable of producing both a frame portion color to be viewed when the light source is turned off and the light emission color to be obtained when the light source is turned on. This is inferior to the structure of this embodiment in that a general-purpose light source cannot be used. The inability to obtain a desired color also makes this inferior to the structure of this embodiment because there is generally only a limited selection of light source colors to choose from.

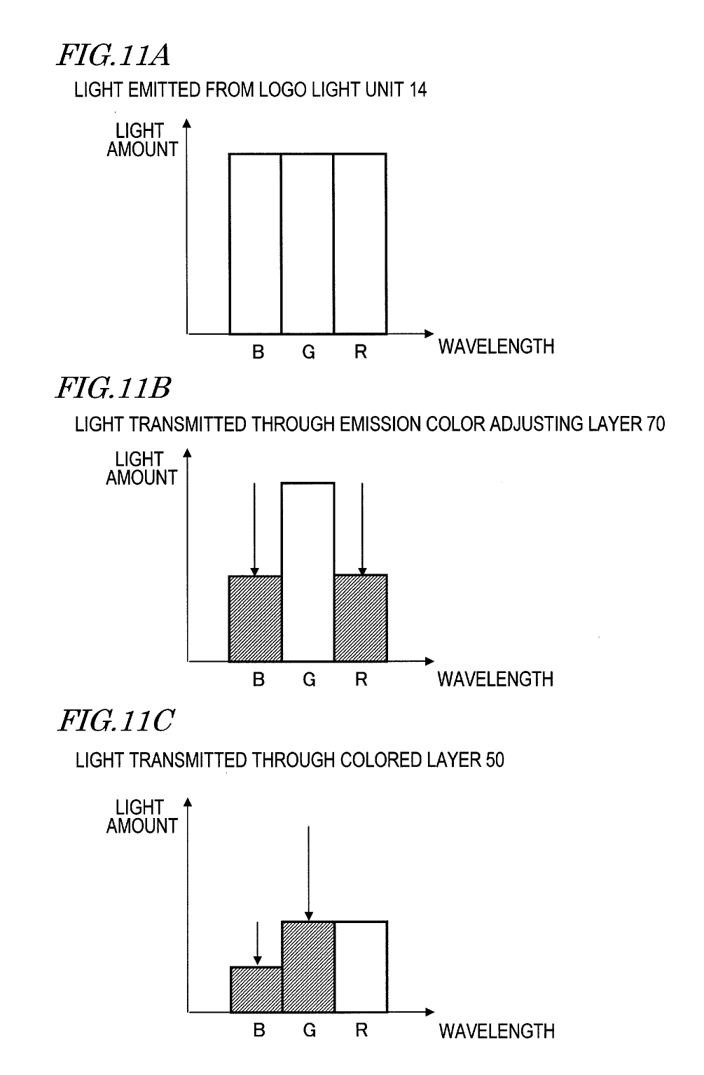

The logo portion 18 in this embodiment is lit in a color close to that of light emitted from the logo light unit 14 by using the complementary color of the colored layer 50 for the emission color adjusting layer 70. However, the color of the emission color adjusting layer 70 does not need to be the complementary color of the colored layer 50. For example, the logo portion 18 can be lit in yellow by using the colored layer 50 that is red and the emission color adjusting layer 70 that is green as illustrated in FIGS. 11A to 11C. FIG. 11A illustrates the spectral distribution of light emitted from the logo light unit 14 (white light). As illustrated in FIG. 11B, other color light components than the green light component (the red light component and the blue light component) are mostly lost when the white light is transmitted through the green emission color adjusting layer 70. In the example of FIG. 11B, approximately 50% of red light and blue light is lost. As illustrated in FIG. 11C, approximately 50% of other color light components than the red light component (the green light component and the blue light component) is further lost upon transmission through the colored layer 50, which makes the green light and the red light a substantially equal amount. The light exiting the logo portion 18 is consequently viewed as yellow, which is a mixture of green and red. In the example described above, where light emitted from the logo light unit 14 is ideal white light and the colored layer 50 has characteristics that allow the transmission of approximately 50% of green light and blue light, the transmittance of red light and blue light in the emission color adjusting layer 70 is set to approximately 50%. In the case where the spectrum of the light source and the light transmission characteristics of the colored layer 50 differ from those in the example described above, the transmitted colors and transmittance of the emission color adjusting layer 70 are adjusted such that ultimately display in a desired color is obtained.

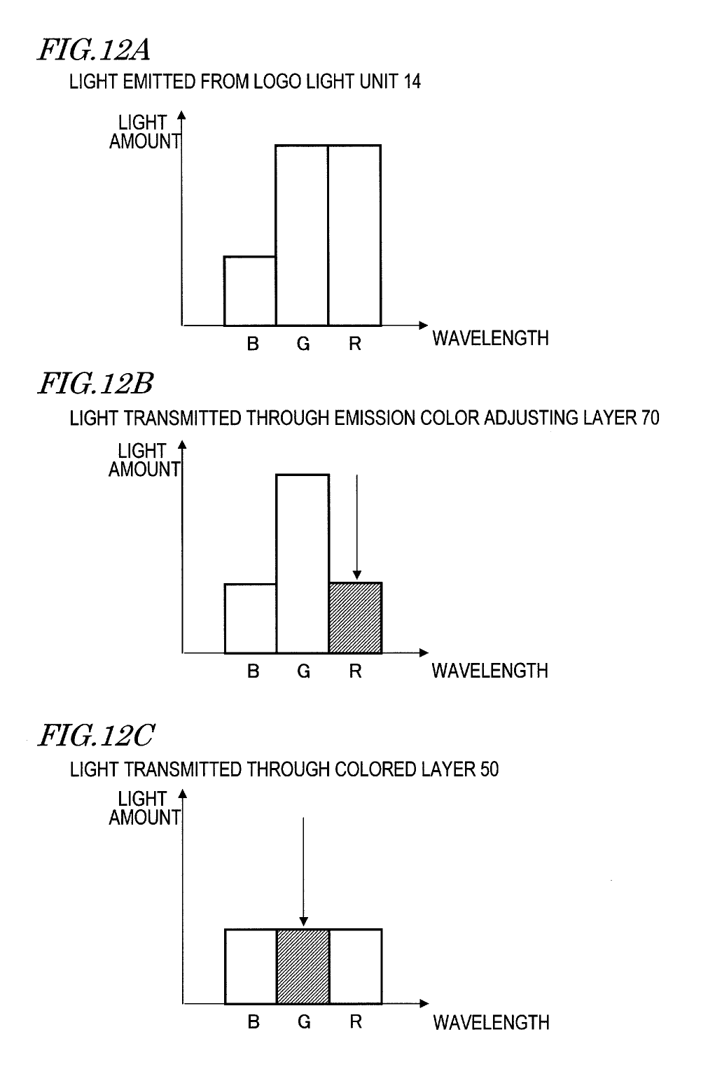

The light source in this embodiment is the logo light unit 14 which is a white light source, but it is not always necessary to use a white light source. FIGS. 12A to 12C are diagrams illustrating as an example a case where the logo light unit 14 emits yellow light, the color of the frame portion is pink (magenta), and a logo is lit in white. The emission color adjusting layer 70 in this example is a light-transmissive colored layer that absorbs mainly red light and that transmits mainly cyan (a mixture of green and blue) colored light. As illustrated in FIG. 12A, the logo light unit 14 emits light that includes a large amount of red component and green component. The emitted light also includes a small amount of blue light. When the emitted light is transmitted through the emission color adjusting layer 70, most of the red component is lost as illustrated in FIG. 12B. The light transmission characteristics of the emission color adjusting layer 70 here have been adjusted so as to make the amount of red component approximately equal to the amount of blue component. Subsequently, most of green light is lost in the colored layer 50, thereby making the red light and the blue light approximately equal in light amount as illustrated in FIG. 12C. In this example, too, the light transmission characteristics of the emission color adjusting layer 70 are adjusted in advance such that the light exiting the colored layer 50 includes the red component, the green component, and the blue component in approximately equal amounts. As a result of the processing described above, the light exiting the colored layer 50 is ultimately white light, although reduced in intensity. Thus, when the light source used is not a white light source, too, the frame portion can have a desired color and the logo can be lit in a desired color.

As described above, according to this embodiment, the digital photo frame 400 which has a high degree of freedom in selecting colors that are visible when the light source is turned on and when the light source is turned off can be provided at a low cost.

Described next are other components and functions of the digital photo frame 400 according to this embodiment. The digital photo frame 400 may further include, for example, the following components and functions.

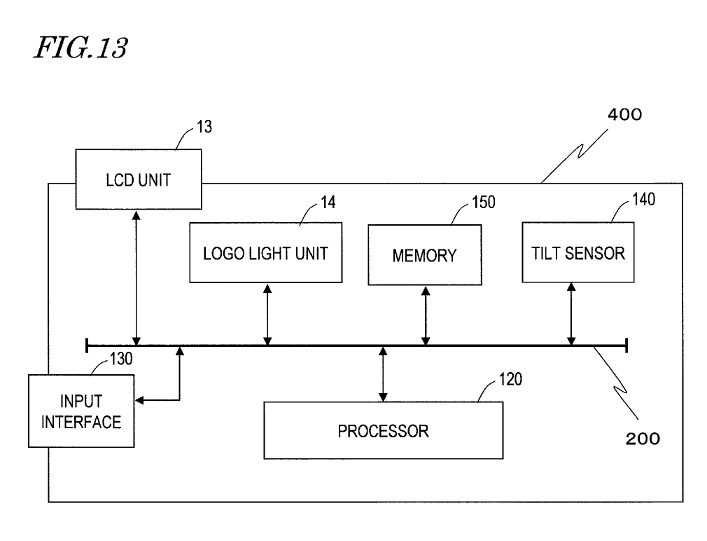

FIG. 13 is a block diagram illustrating the hardware structure of the digital photo frame 400. The digital photo frame 400 include, in addition to the components described above, a processor 120, an input interface 130, a tilt sensor 140, and a memory 150. The processor 120 includes a CPU and a GUI, and controls the operation of the LCD unit 13 and the logo light unit 14. The input interface 130 can be a button or a touch panel through which an input is received from a user. The tilt sensor 140 is a sensor that has a function of detecting a tilt of the device, for example, an acceleration sensor or an angular velocity sensor. The memory 150 is a storage medium where data of photographs and various types of data generated in the process of executing processing of the respective function portions are saved.

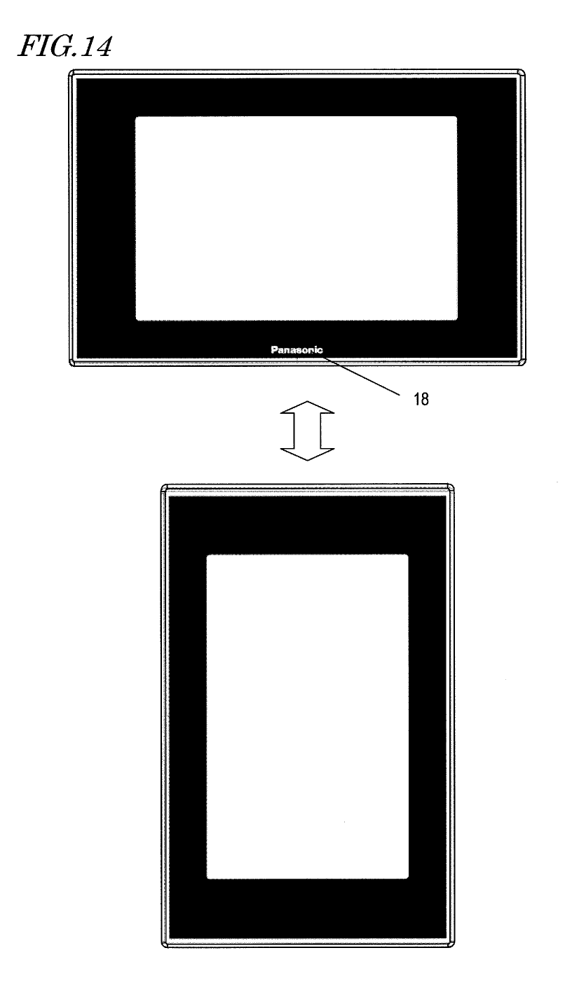

The digital photo frame 400 of this embodiment may have a function of stopping light emission from the logo portion 18 when the main body in a lateral position is rotated to a longitudinal position as illustrated in FIG. 14. This function is implemented by the processor 120 by issuing an instruction to turn off to the logo light unit 14 based on the tilt detected by the tilt sensor 140. This prevents the device from displaying a logo in an unintended manner when the logo portion 18 is not designed to adapt to the longitudinal position of the device.

The digital photo frame 400 may also have a function of switching between displaying and not displaying the logo portion 18 in response to an input from the user. This function is implemented by the processor 120 by controlling the turning on/off of the logo light unit 14 based on the user's instruction input via the input interface 130. This provides a function of manually erasing a logo to the user who does not like logo display or the like.

In the manner described above, by allowing a flexible adjustment of how the logo portion 18 is displayed based on the state of the device or the user's operation, the digital photo frame 400 with higher added values can be provided.

A light emission method according to the present invention which is applied to the digital photo frame 400 in this embodiment can be used in any device. Examples in which this light emission method is applied to other electronic devices are described below.

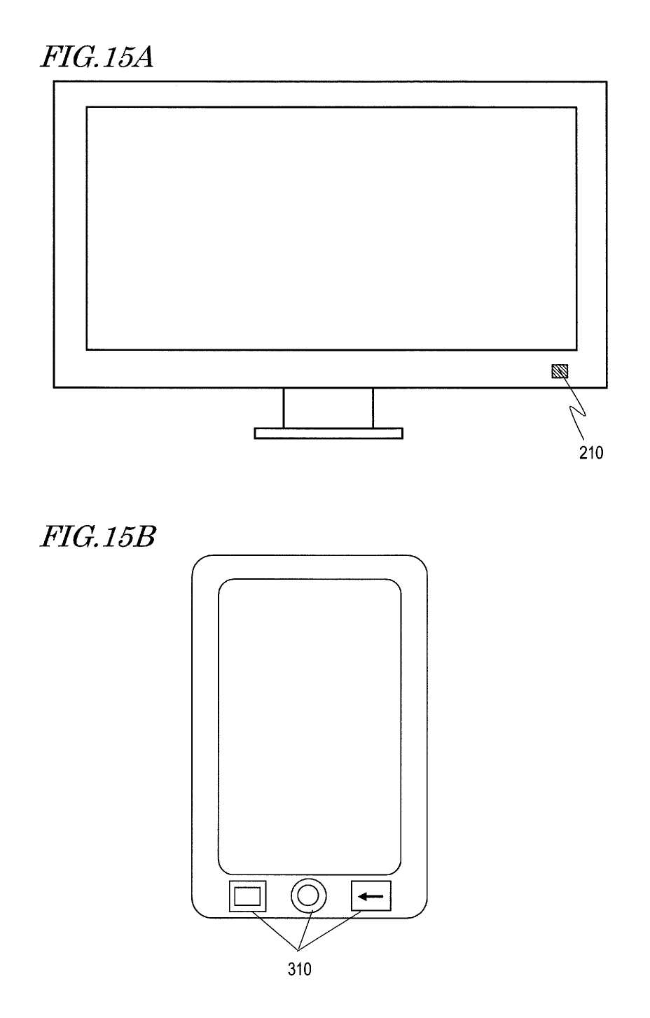

FIG. 15A illustrates an example in which the light emission method according to the present invention is applied to a common television set or display. The light emission method described above is used to implement a power source pilot portion 210 in a frame portion of this type of device. This makes it possible to display in a desired color while using the same light source for variations of the device that are varied in the color of the frame portion. The light emission method of the present invention is also expected to improve the product design because the power source pilot portion 210 can be made indistinguishable from the frame portion when the light source is turned off. In this example, the light pattern displayed can be a simple shape such as a circle or a rectangle, instead of letters or a complex graphic form.

FIG. 15B is a diagram illustrating an example in which a light emitting unit according to the present invention is applied to a personal digital assistant. Some personal digital assistants are provided with input buttons 310, which are displayed on a touch panel by software. The input buttons 310 may be implemented by the light emission method described above. This is beneficial because the input buttons 310 can be displayed in a uniform color irrespective of color differences between terminals.

The present invention makes it possible to easily display a light pattern of an arbitrary shape in an arbitrary color by using a general-purpose material. The present invention is therefore applicable to all kinds of devices including digital photo frames and television sets for kitchens. The present invention is particularly effective when a product is to be made available in a variation of colors such as pink, black, and white.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2011-199300 filed on Sep. 13, 2011 and No. 2012-003831 filed on Jan. 12, 2012, the entire contents of which are hereby incorporated by reference.

What is claimed is:

1. An electronic device for displaying a light pattern in a section of a surface by turning on a light source, comprising:
the light source;
a first light-transmissive colored layer provided on the surface and having reflectance and transmittance that peak in a wavelength range of light of a first color; and
a second light-transmissive colored layer provided on a path of light that is emitted from the light source and reaches the first light-transmissive colored layer, the second light-transmissive colored layer having transmittance that peaks in a wavelength range of light of a second color different from the first color,
wherein the second light-transmissive colored layer has light transmission characteristics adjusted such that light of a desired color exits the section of the surface where the light emitted from the light source reaches when the light source is turned on.

2. An electronic device according to claim 1, further comprising a light shielding layer disposed between the light source and the first light-transmissive colored layer, a part of the light shielding layer including a light transmitting pattern,
wherein the second light-transmissive colored layer is placed along a path of light being emitted from the light source, transmitted through the light transmitting pattern, and reaching the first light-transmissive colored layer, and
wherein the second light-transmissive colored layer has light transmission characteristics adjusted such that light of a desired color exits the section of the surface where the light emitted from the light source and transmitted through the light transmitting pattern reaches when the light source is turned on.

3. An electronic device according to claim 1, wherein the light source is an aggregation of a plurality of light source components arranged so as to display the light pattern in the section of the surface.

4. An electronic device according to claim 1, wherein, in the section of the surface, light reflected from the first light-transmissive colored layer is visible when the light source is turned off, and a color of light emitted from the light source and transmitted through the second light-transmissive colored layer and the first light-transmissive colored layer is visible when the light source is turned on.

5. An electronic device according to claim 1, wherein the second light-transmissive colored layer has light transmission characteristics adjusted such that light of the same color as that of light emitted from the light source exits the section of the surface when the light source is turned on.

6. An electronic device according to claim 1, wherein the second color is a complementary color of the first color.

7. An electronic device according to claim 6, wherein one of the first color and the second color is a color selected from the group consisting of red, green, and blue.

8. An electronic device according to claim 1, wherein the light source is a white light source.

9. An electronic device according to claim 1, wherein the first light-transmissive colored layer and the second light-transmissive colored layer are each made from one of ink and paint.

10. An electronic device according to claim 2, wherein the light transmitting pattern is shaped like one of letters and a graphic form.

11. An electronic device according to claim 1, further comprising:
an input interface configured to receive an instruction from a user; and
a processor configured to control turning on and off of the light source based on the instruction from the user.

12. An electronic device according to claim 1, further comprising:
a sensor configured to ditect a tilt; and
a processor configured to control turning on and off of the light source based on the tilt detected by the sensor.

13. A light emitting unit for displaying a light pattern in a section of a surface of a device by turning on a light source, comprising:
the light source;
a first light-transmissive colored layer having reflectance and transmittance that peak in a wavelength range of light of a first color; and
a second light-transmissive colored layer provided on a path of light that is emitted from the light source and reaches the first light-transmissive colored layer, the second light-transmissive colored layer having transmittance that peaks in a wavelength range of light of a second color different from the first color,
wherein the second light-transmissive colored layer has light transmission characteristics adjusted such that light of a desired color exits the section of the surface where the light emitted from the light source reaches when the light source is turned on.

14. A light emitting unit according to claim 13, further comprising a light shielding layer disposed between the light source and the first light-transmissive colored layer, a part of the light shielding layer including a light transmitting pattern,
wherein the second light-transmissive colored layer is placed along a path of light being emitted from the light source, transmitted through the light transmitting pattern, and reaching the first light-transmissive colored layer, and
wherein the second light-transmissive colored layer has light transmission characteristics adjusted such that light of a desired color exits the section of the surface where the light emitted from the light source and transmitted through the light transmitting pattern reaches when the light source is turned on.

15. A light emitting unit according to claim 13, wherein the light source is an aggregation of a plurality of light source components arranged so as to display the light pattern in the section of the surface.

16. A light-transmissive panel for use in an electronic device for displaying a light pattern in a section of a surface by turning on a light source, comprising:
a first light-transmissive colored layer having reflectance and transmittance that peak in a wavelength range of light of a first color; and
a second light-transmissive colored layer provided on a path of light that is emitted from the light source and reaches the first light-transmissive colored layer, the second light-transmissive colored layer having transmittance that peaks in a wavelength range of light of a second color different from the first color,
wherein the second light-transmissive colored layer has light transmission characteristics adjusted such that light emitted from the light source and transmitted through the first light-transmissive colored layer has a desired color when the light source is turned on.

17. A light-transmissive panel according to claim 16, further comprising a light shielding layer disposed close to the first light-transmissive colored layer, a part of the light shielding layer including a light transmitting pattern,
wherein the second light-transmissive colored layer is placed along a path of light being emitted from the light source, transmitted through the light transmitting pattern, and reaching the first light-transmissive colored layer, and
wherein the second light-transmissive colored layer has light transmission characteristics adjusted such that light being emitted from the light source, transmitted through the light transmitting pattern, and exiting the first light-transmissive colored layer has a desired color when the light source is turned on.
